(19) United States
(12) Patent Application Publication
(10) Pub. No.: US 2011/0146256 A1
(43) Pub. Date: Jun. 23, 2011

(54) CONTROL ARRANGEMENT FOR A VALVE-CONTROLLED HYDROSTATIC DISPLACEMENT UNIT

(76) Inventors: Alejandro Lopez Pamplona, Horb (DE); Bjoern Beuter, Hirrlingen (DE)

(21) Appl. No.: 12/963,196

(22) Filed: Dec. 8, 2010

(30) Foreign Application Priority Data
Dec. 15, 2009 (DE) 10 2009 058 365.3

(51) Int. Cl. F15B 21/02; F15B 21/08

(52) U.S. Cl. 60/403; 60/463

(57) ABSTRACT

A control arrangement for a valve-controlled hydrostatic displacement contains a control unit for controlling the valve-controlled hydrostatic displacement machine, a sensor electronics portion for detecting sensor data of a power electronics portion and of the valve-controlled hydrostatic displacement machine, and the power electronics portion for furnishing a current necessary for operating the valve-controlled hydrostatic displacement machine. The control unit, the sensor electronics portion, and the power electronics portion are connected, as are the sensor electronics portion, the power electronics portion, and the valve-controlled hydrostatic displacement machine, which in turn are each connected to one another via bidirectional communications lines. The functionalities of the control unit, the sensor electronics portion, the power electronics portion, and the valve-controlled hydrostatic displacement machine are assigned, separately from one another, to these units and portions, and data and information are capable of being exchanged between these units and portions. The control unit is arranged for detecting information from the sensor electronics portion, the power electronics portion, and/or the valve-controlled hydrostatic displacement machine, centrally in only the control unit, and reacting to information which represents a changed situation and, in an interacting fashion, adapting the sequence control for the valve-controlled hydrostatic displacement machine.

### CROSS-REFERENCE TO RELATED APPLICATION

This application is based on German Patent Application 10 2009 058 365.3 filed on Dec. 15, 2009.

### BACKGROUND OF THE INVENTION

1. Field of the Invention

The invention relates to a control arrangement for a valve-controlled hydrostatic displacement machine, having triggering electronics for triggering, regulating and operating a valve-controlled hydrostatic displacement machine or piston engine, and relates in particular to the furnishing of suitable software and hardware components for triggering, regulating and operating a valve-controlled hydrostatic displacement machine.

2. Description of the Prior Art

Hydrostatic drives, comprising a hydropump which drives a hydromotor via a fluid line, have in the meantime gained wide distribution in mechanical and systems engineering but also in automotive engineering. Among these hydraulic or hydrostatic displacement engines (piston or hydraulic engines) used in this field as drives are pumps and motors that operate on the principle of positive displacement and as a rule have the same structural layout. By means of suitable controlling of the flow of liquid, pumps in particular can function as motors, and vice versa. Because of the distinction in the direction of operation, it is true of so-called hydropumps that they convert mechanical power into hydraulic power, and for so-called hydromotors that they convert hydraulic power back into mechanical power.

More recent drive mechanisms that are especially suitable for vehicles are digital displacement machines, which operate on the principle of “digital displacement” and are designed predominantly as multi-cylinder pumps and/or multi-cylinder motors and/or multi-cylinder pump motors, for instance as radial piston machines. In this type of machines, each cylinder has at least two valves, such as plate valves, slide valves, combination valves, and the like, of which one is a low-pressure valve communicating with a low-pressure fluid, and the other is a high-pressure valve communicating with a high-pressure fluid. A microcontroller reads a piston position or shaft position sensor and controls or regulates one or more of the valves. A hydraulic motor is attained when the high-pressure valve is triggered as well.

While the above type of drive mechanisms has considerable advantages, particularly in the automotive field, or in other words for motor vehicles and in that field for instance as a gear-axle drive unit, advantages such as a fast response speed and inherent energy efficiency because of high efficiency, until now it was necessary to use a complicated triggering chain, comprising among other things a circuit board assembly, each with at least one microcontroller as the control unit, one interface, one FPGA (field programmable gate array), as an array of logic gates that can be configured in the application field, and field effect transistors.

Disadvantageously, as a result, the professional knowledge employed and the functionality of the arrangement are distributed over the entire triggering chain. Since the FPGA, operating like a port expander, receives only bus signals from the microcontroller and shifts them within a predeterminable time to corresponding end stages and as a result triggers the end stages, signals are forwarded in only one direction and do not contain any diagnostic or feedback signals. Because of the lack of feedback among the components, error sources are furthermore quite difficult to locate. The FPGA itself is vulnerable to error and difficult to analyze. Finally, the use of FPGAs in the automotive field may not be permitted in every case.

Thus the known triggering chain, which is based on the use of an FPGA, prevents use in mass production. Moreover, the assembly having the field effect transistors has no diagnosis capabilities, so that errors cannot be detected. Still, there is a need for such error detection in the on-road field, for instance for on-board diagnosis (OBD) directly in a vehicle.

### OBJECT AND SUMMARY OF THE INVENTION

It is therefore an object of the invention to improve the known, complicated triggering chain of the triggering electronics for a valve-controlled hydrostatic displacement machine and to create an optimized triggering chain that furnishes diagnostic capabilities and makes on-road use possible.

By means of an optimized triggering chain, which includes a standard control unit with corresponding power electronics and sensor electronics, the functionalities are clearly separated. Data and information are exchanged between the components, so that on the basis of the diagnostic capabilities thus arising, the demands for use in the on-road field are met.

The fundamental concept of the invention is thus, by means of an optimized triggering chain, which includes a standard control unit with corresponding power electronics and sensor electronics, to clearly separate functionalities and make it possible for data and information to be capable of being exchanged among the components and that interaction can take place. Further improvements in terms of diagnostic capabilities, installation space, and pressure and temperature compensation for electronic components and the entire system can be attained by the use of intelligent circuits on the part of the power electronics. Moreover, by the communication via buses, economies in terms of port contacts at the control unit are possible.

In particular, according to the invention, for instance and among other things by means of a reduction in processor load by shifting the regulation and/or diagnosis to an intelligent power electronics portion, advantages are attained in view of fast error location, a low number of interfaces, and fast interventions into a sequence control by means of bidirectional data and information exchange. Moreover, error sensor electronics can be detected, and it becomes possible to integrate standard components with software and/or hardware synergies in development and production.

According to the invention, the control arrangement for a valve-controlled hydrostatic displacement machine is characterized by: at least one control unit for controlling the valve-controlled hydrostatic displacement machine; a sensor electronics portion for detecting sensor data of a power electronics portion and of the valve-controlled hydrostatic displacement machine; and the power electronics portion, for furnishing a current required for operating the valve-controlled hydrostatic displacement machine via power-transmitting line connections between the power electronics portion and the valve-controlled hydrostatic displacement machine; wherein the at least one control unit, the sensor electronics portion, and the power electronics portion, as well as the sensor electronics portion, the power electronics portion, and the valve-controlled hydrostatic displacement machine are each connected to one another, via bidirectional communications lines, which differ from the line connections transmitting the power, in such a way that functionalities of the at least one control unit, the sensor electronics portion, the power electronics portion, and the valve-controlled hydrostatic displacement machine are assigned, separately from one another to these units and portions, and data and information are capable of being exchanged between these units and portions; and the at least one control unit is arranged for detecting information from the sensor electronics portion, the power electronics portion, and/or the valve-controlled hydrostatic displacement machine, centrally in only the at least one control unit, and reacting to information which represents a changed situation and, in an interacting fashion, adapting the sequence control for the valve-controlled hydrostatic displacement machine.

According to the invention, the evaluation is not limited to evaluation in only precisely one control unit; instead, the evaluation per se can also be distributed to a plurality of control units, and the power-transmitting line connections differ physically from the bidirectional communications lines.

Preferably, the bidirectional communications lines are formed by a CAN bus having at least one data input-and-output interface, and/or having a pulse width modulation interface and/or having a serial interface and/or having an interface to a control device of a mass store, and/or having an interface to an analog/digital converter.

Also or alternatively, it is preferred that the bidirectional communications lines, within the overall system, furnish transmission of bidirectional signals by means of global system variables.

In the context of the information, the information is among other things error information, by means of which an electrical error, a short circuit to a battery power supply, a short circuit to a ground potential, a line interruption, a sensor error, a faulty operating state, and/or a communications error between portions of the control arrangement is detectable.

Preferably, the at least one control unit is arranged for triggering intelligent integrated circuits which are disposed in the sensor electronics portion and/or in the power electronics portion, and is arranged in the event of an error to identify an affected component as defective and no longer to trigger it, and to distribute the incident load among the remaining, nondefective components.

Also preferably, a power electronics portion is disposed directly on a valve of the valve-controlled hydrostatic displacement machine, and the at least one control unit sends a control signal, generated by it, directly to the power electronics portion disposed on the valve.

### BRIEF DESCRIPTION OF THE DRAWINGS

The invention will be better understood and further objects and advantages thereof will become more apparent from the ensuing detailed description of a preferred embodiment taken in conjunction with the drawings, in which:

FIG. 1 is a simplified block diagram of a triggering chain in one exemplary embodiment of the invention;

FIG. 2 is a simplified block diagram of an improved triggering chain in the exemplary embodiment of the invention; and

FIG. 3 is a simplified block diagram of a known triggering chain version.

### DESCRIPTION OF THE PREFERRED EMBODIMENT

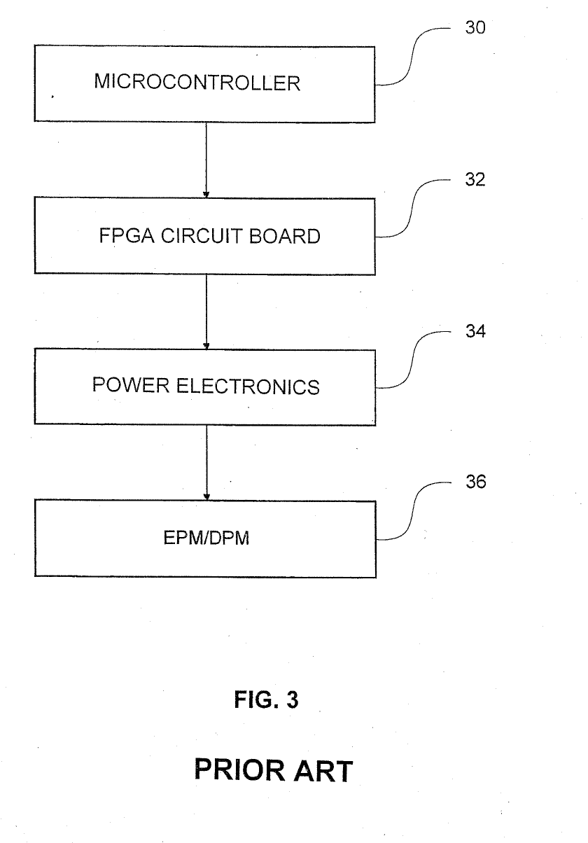

FIG. 3 shows a simplified block diagram of a known version of a triggering chain for triggering a microcontroller 30, an FPGA circuit board 32 or field programmable gate array circuit board, as an arrangement of logic gates that can be configured in the application field, a power electronics assembly 34 that contains field effect transistors, and finally a valve-controlled hydrostatic displacement machine 36, or engine pump motor/drive pump motor (EPM/DPM).

In FIG. 3, the entire triggering chain is unidirectional; that is, it works solely in one direction: The microcontroller 30, as a control unit into which the intelligence of the system is programmed, issues activation commands, via a serial bus not shown in detail, to the FPGA circuit board 32 or assembly comprising a circuit board with FPGAs disposed on it. The circuit board 32 receives the commands from the microcontroller 30 and triggers the downstream individual power stages of the power electronics assembly 34 accordingly; the power electronics makes a requisite current available for the valves of the valve-controlled hydrostatic displacement machine 36. To that end, so-called time-data sets or timings, must be stored in memory in the FPGA circuit board 32 for supplying current to the valves, and these data sets determine how long and with what current a valve of the displacement machine 36 will be supplied. As a consequence, some of the intelligence of the entire system must be also be present on the FPGA circuit board 32.

The known FPGA circuit board 32, because of the mode of operation in only one direction of the known triggering chain, however, has no possibilities whatever for monitoring the power electronics assembly 34. Commands are therefore executed unconditionally, without any possibility of reacting to an incident problem, the failure of a valve, or the like in the downstream power electronics assembly 34 and/or in the displacement machine 36. Thus in principle, in this known structure only control is done, but not regulation. Because of the lack of feedback to the actual power electronics assembly 34, the microcontroller 30 also lacks any capability of varying or changing a mode of operation if necessary if a problem arises, so that in the event of failure of a valve of the displacement machine 36, for instance, it continues to try to activate the corresponding cylinder of the displacement machine 36, without any error correction strategy or capability.

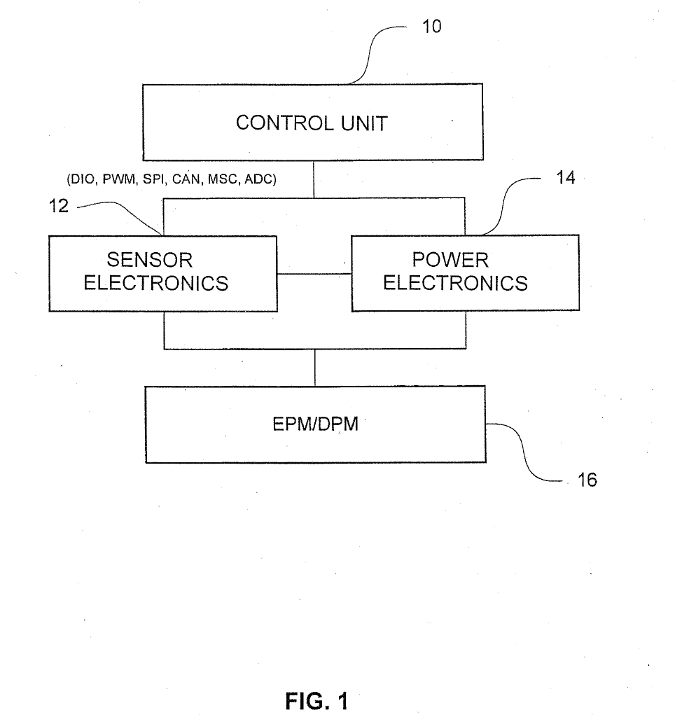

FIG. 1 shows a simplified illustration of the triggering chain of the hydrostatic displacement machine in one exemplary embodiment, having at least one control unit 10, which can for instance be at least one microcontroller or an engine control unit containing at least one microcontroller, a sensor electronics or sensor electronics portion 12, and power electronics or a power electronics portion 14 for regulating a valve-controlled hydrostatic displacement machine 16 as the triggered engine pump motor/drive pump motor (EPM/DPM). The triggering chain of FIG. 1 comprises both software and hardware components. Only by means of connections of the components as shown in FIG. 1 and communication by way of these connections, or in other words by an interplay of the components, is it possible to generate and obtain error information from various regions of the triggering chain, to evaluate such error information centrally via the at least one control unit 10, and to react to a new situation. However, the invention is not limited to that; on the contrary, still other combinations of the aforementioned elements and blocks that meet the control purpose are also possible, to suit the requirements of a specific application.

With regard to a material connection of the portions and blocks shown in FIG. 1, fluid-carrying segments communicate by means of pipelines or hollow conductors and are connected to current and/or voltage as well as segments that process data signals by means of electric conductor tracks. In particular, the triggering chain is intrinsically in communication internally by means of suitable buses, for example and preferably a CAN data bus or some other bus system suitable for the purpose, which also make the connection with the control unit 10.

The CAN data bus used in this exemplary embodiment for instance transmits a driver demand, for instance his request for power, via an accelerator pedal (not shown) and/or a brake pedal (not shown) of a vehicle, in which the triggering chain of the exemplary embodiment is used, to various responsible control units or engine control units, which then, in a manner known per se, regulate and/or control the collaboration of drive components to suit particular dynamic requirements. At the same time, the status of all the drive components is monitored via bus data forwarding. Advantageously, the aforementioned control units can also have adaptable functions and performance graphs, so that a number of possible drive variants can be taken into account in the most suitable possible way.

Between the control unit 10 and the portions, downstream of it, of the sensor electronics 12 and power electronics 14 and the displacement machine 16, respective suitable interfaces are furnished. These include, to name only a few, not shown per se, preferably the CAN (controller area network) interface or some other bus system suitable for the purpose, a DIO (digital input/output) interface for data input and output, a PWM or pulse width modulation interface, an SPI (serial peripheral interface) for serially connectable external or peripheral devices, an MSC interface to a control device of a mass store, and an ADC (analog/digital converter) interface to an analog/digital converter. In general, via these interfaces, all kinds of communications and/or control signals are carried, and these interfaces can also be bus interfaces, such as Flexray, EEPROM, and the like.

A system error occurring in the sensor electronics portion 12, the power electronics portion 14 or the displacement machine 16 can for instance be an electrical error, such as a short circuit to a battery (not shown), a short circuit to a system ground potential, an interruption for instance of a line connection resulting in an open load, a communications error at the SPI, detection of an excessively high temperature in the vicinity of an intelligent circuit, and the like. Other system errors can be due to sensor errors in system sensors involved and to faulty operating states associated with them, and the like.

It will be noted that the intelligent integrated circuits or IC components used for the field of engine control units are highly integrated and are adapted in such a way to one another, and have gone through such complicated processes for quality assurance, that functionalities which are needed for attaining the triggering chain are supported by only one electronic component that requires little space on a circuit board. Among others, such functionalities are preferably the representation of a current booster phase or current amplifier phase upon triggering of valves, embodied as solenoids, of the displacement machine 16, which serve to build up as fast as possible in these magnetic circuits by way of briefly drawing energy for generating a peak current for fast acceleration from a booster or amplifier capacitor; the current booster phase can then be followed suitably by maintenance current levels, the furnishing of a capability of switching on or off and/or switchover of various current levels, and fast extinction of magnetic circuits.

For detecting such system errors, beginning at the level of the sensor electronics portion 12 and of the power electronics portion 14, sensor values of various sensors installed in the system and—preferably actual—operating states detected are forwarded to the control unit 10 in the form of sensor values, data and signals, among other things.

The control unit 10 takes over the detected values, data and/or signals forwarded from the level of the sensor electronics portion 12 and of the power electronics portion 14 and then, on the basis of them, carries out various calculations in a calculation portion (not shown) and evaluations in an evaluation portion (not shown), or an evaluation logic furnished for the purpose.

Model-based calculation and/or plausibility checking can be performed as examples of such calculations. Model-based calculation, on the basis for instance of predetermined characteristic curves, tables, and/or other data, such as empirical data, serves to ascertain predetermined values for the actual system detection values detected and the data and/or signals to be taken into account and also serves, for the various predetermined values, to determine permissible tolerance ranges within which the system detection values, data and/or signals should or must be located in order to be capable of being classified as either valid or in other words error-free, or invalid or in other words erroneous. The plausibility check can additionally be used in the model-based calculation to substantiate or counter the outcome of the model-based calculation, or can be used as an additional, separate criterion. The plausibility calculation can serve for example to ascertain quickly and/or as an estimated finding whether a value to be checked can still be an appropriate value so that more-complicated model-based calculation must be performed, or as already so far from system values that the more-complicated model-based calculation can safely be dispensed with. As a result, a fast reaction time of the triggering chain can be attained, or the available computation power can be distributed more suitably. Moreover, it can be provided that the control unit 10 performs a monitoring operation, which responds for instance to the lack of a detected value, data or signal, or which from threshold values detects that predetermined ranges and the like have been overshot or undershot. The evaluation logic, finally, can also include suitable circuit arrangements and/or routines for suitable conversion and/or processing, such as filtering, amplification, or buffer storage, of the values, data and signals forwarded to the control unit 10 into correspondence values that can be better further processed.

If the control unit 10 finds that an error has occurred that requires changed control commands and/or reactions, for instance in accordance with a predetermined model, then the control unit 10 converts this into control commands, reactions to reported errors, and monitoring strategies that are suitable for the power electronics portion 14 and issues correspondingly required control commands, values, data and/or signals for corrected control or regulation of the pump motor 16.

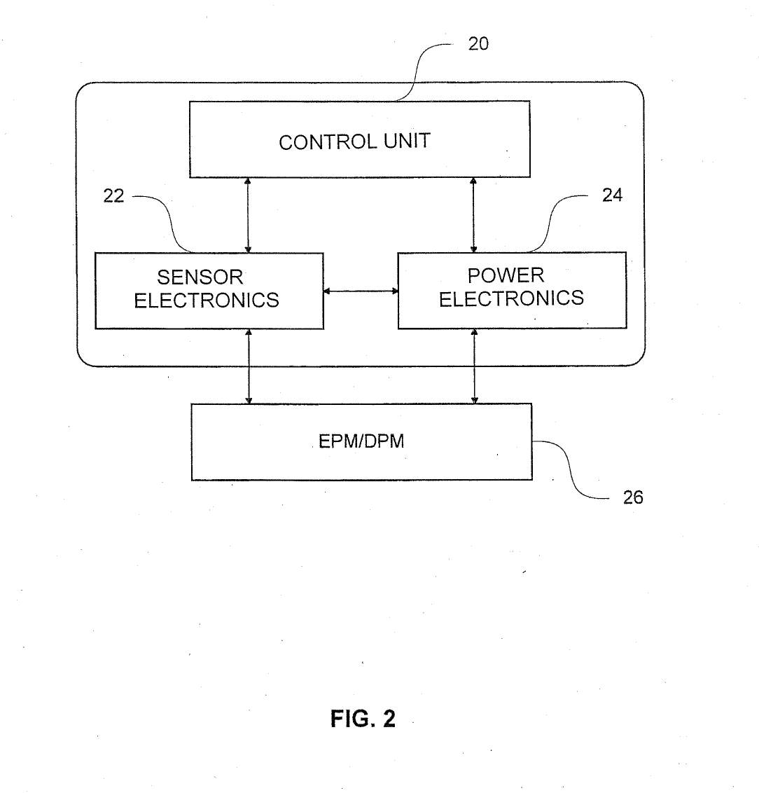

FIG. 2 shows what compared to FIG. 1 is a further-improved structure of a triggering chain according to the exemplary embodiment of the invention. Here, a control unit 20, as indicated by the outline, triggers intelligent integrated circuits or ICs in the sensor electronics portion 22 and/or the power electronics portion 24 directly, which portion then furnishes a requisite current for a valve-controlled hydrostatic displacement machine or a pump motor 26 (EPM/DPM). These intelligent integrated circuits can include capabilities for component error detection, such as detecting a short circuit to the battery and/or ground, an excessive temperature detection, and so forth. Evaluating such error information then opens up additional capabilities for the control unit 20 with regard to system or status monitoring of the downstream components of the triggering chain having the pump motor 26.

The structure of the triggering chain furthermore contains a corresponding sensor electronics 22 for current measurements, temperature measurements, voltage measurements, and the like, in the form of current sensors, temperature sensors and voltage sensors and the like, which are used to exchange bidirectionally detected information among the various components of the triggering chain via buses, data lines, and the like.

For example, such bidirectional bus and data connections exist between the control unit 20 and the sensor electronics portion 22, between the control unit 20 and the power electronics portion 24, between the sensor electronics portion 22 and the power electronics portion 24, between the sensor electronics portion 22 and the pump motor 26, and between the power electronics portion 24 and the pump motor 26. It will be noted that here the bidirectional communication between the control unit 20 and the sensor electronics portion 22 can take place by way of CAN and/or, if the sensor electronics portion 22 is for instance linked directly to the control unit 20, this can be done internally in the engine control unit by means of other suitable communications capabilities, such as via global variables, also known as messages, which can be tracked for their data consistency.

The bidirectional communications lines can thus furnish a transmission of bidirectional signals by means of global system variables. As a result, by means of the triggering chain of the present exemplary embodiment, system and status information can also be furnished, which need not necessarily be information pertaining to any errors but can also involve information which can be used for bringing about and/or improving system stability (robustness), and for optimization for instance in terms of transit times, wear phenomena, pulsations, and the like.

As a result, the control unit 20 is capable of ascertaining and/or monitoring the status of the overall system, controlled, regulated and/or monitored by it, on the basis of the detected information, data and signals. In the structure shown, the intelligence of the entire system, or in other words the control software, characteristic curves, models, time data sets, and the like, is thus collected or concentrated at only one location, that is, in the control unit 20.

By means of the exchange of information between the various components of the triggering chain by way of the above-described connection structure, in combination with the intelligent integrated circuits in the sensor electronics portion 22, the power electronics portion 24 and optionally the pump motor 26, this control unit 20 is thus, by itself and independently, capable of reacting to error situations in the downstream system. For instance, if the failure of a valve of the pump motor 26 or of a power end stage in the power electronics portion 24 is detected, this power end stage can be identified by the control unit 20 as “damaged” and shut off for the further course of operation, and in that case the incident load can be distributed to or among the other cylinders/components of the power electronics portion 24 and of the pump motor 26.

In a modification of the improved triggering chain of the exemplary embodiment of the invention, the power electronics required for a valve (not shown) of the pump motor 26 can be disposed “on-board”, directly on the valve. In this case, a control signal generated by the control unit 20 can be sent directly, via suitably designed bus connections, to the valve containing the power electronics, and/or information data detection and monitoring can be done by the control unit 20 directly at such a valve.

Thus, by optimizing the triggering chain using a standard control unit 20 and a corresponding power electronics portion 24 and sensor electronics portion 22, the triggering chain that is improved according to the invention for a valve-controlled hydrostatic displacement machine enables a clear separation of the individual functionalities, an exchange of data and information among the individual components, and an interaction among them, in conjunction with improved diagnostic capabilities, improved space and improved temperature management for the electronic components, while at the same time economizing on port contacts as a result of the intelligent integrated circuits used for the purpose.

Because of the integration of standard components for software, that is, control programs and sequence controllers, and hardware, that is, electronic components, are integrated, which advantageously achieves the utilization of synergies in the development and production of various fields, the result is simpler, more-economical mass production with the aforementioned properties, while at the same time furnishing fast error location, a bidirectional exchange of information and data that permits fast interventions into the sequence control, and the detection of error sensor electronics. The use of field-programmable logic, which until now was a severe restriction as well as critical and complicated, is dispensed with.

Thus, a control arrangement for a valve-controlled hydrostatic displacement machine has been described, containing: at least one control unit for controlling the valve-controlled hydrostatic displacement machine; a sensor electronics portion for detecting sensor data of a power electronics portion and of the valve-controlled hydrostatic displacement machine; and the power electronics portion for furnishing a current, necessary for operating the valve-controlled hydrostatic displacement machine, via power-transmitting line connections between the power electronics portion and the valve-controlled hydrostatic displacement machine; wherein the at least one control unit, the sensor electronics portion, and the power electronics portion, as well as the sensor electronics portion, the power electronics portion, and the valve-controlled hydrostatic displacement machine are each connected to one another, via bidirectional communications lines as depicted in FIG. 2, which differ from the line connections transmitting the power, in such a way that functionalities of the at least one control unit, the sensor electronics portion, the power electronics portion, and the valve-controlled hydrostatic displacement machine are assigned, separately from one another to these units and portions, and data and information are capable of being exchanged between these units and portions; and the at least one control unit is arranged for detecting information from the sensor portion, the power electronics portion, and/or the valve-controlled hydrostatic displacement machine, centrally in only the at least one control unit, and reacting to information which represents a changed situation and, in an interacting fashion, adapting the sequence control for the valve-controlled hydrostatic displacement machine.

The foregoing relates to a preferred exemplary embodiment of the invention, it being understood that other variants and embodiments thereof are possible within the spirit and scope of the invention, the latter being defined by the appended claims.

We claim:

1. A control arrangement for a valve-controlled hydrostatic displacement machine, comprising:
at least one control unit for controlling the valve-controlled hydrostatic displacement machine;
a sensor electronics portion for detecting sensor data of a power electronics portion and of the valve-controlled hydrostatic displacement machine; and
the power electronics portion for furnishing a current, necessary for operating the valve-controlled hydrostatic displacement machine, via power-transmitting line connections between the power electronics portion and the valve-controlled hydrostatic displacement machine; wherein
the at least one control unit, the sensor electronics portion, and the power electronics portion, as well as the sensor electronics portion, the power electronics portion, and the valve-controlled hydrostatic displacement machine are each connected to one another, via bidirectional communications lines, which differ from the power-transmitting line connections, in such a way that functionalities of the at least one control unit, the sensor electronics portion, the power electronics portion, and the valve-controlled hydrostatic displacement machine are assigned, separately from one another to these units and portions, and data and information are capable of being exchanged between these units and portions; and
the at least one control unit is arranged for detecting information from the sensor electronics portion, the power electronics portion, and/or the valve-controlled hydrostatic displacement machine, centrally in only the at least one control unit, and reacting to information which represents a changed situation and, in an interacting fashion, adapting the sequence control for the valve-controlled hydrostatic displacement machine.

2. The control arrangement as defined by claim 1, wherein the bidirectional communications lines are formed by a CAN bus or a Flexray bus line having at least one data input-and-output interface, and/or having a pulse width modulation interface and/or having a serial interface and/or having an interface to a control device of a mass store, and/or having an interface to an analog/digital converter.

3. The control arrangement as defined by claim 1, wherein the bidirectional communications lines, within the overall system, furnish transmission of bidirectional signals by means of global system variables.

4. The control arrangement as defined by claim 1, wherein the information is error information, by means of which an electrical error, a short circuit to a battery power supply, a short circuit to a ground potential, a line interruption, a sensor error, a faulty operating state, and/or a communications error between portions of the control arrangement is detectable.

5. The control arrangement as defined by claim 1, wherein the at least one control unit is arranged for triggering intelligent integrated circuits which are disposed in the sensor electronics portion and/or in the power electronics portion, and is arranged in an event of an error for detecting an affected component as defective, and on a basis of integrated error set reaction models, for no longer triggering, or triggering only to a restricted extent within a range of known tolerance ranges, and optionally for distributing an incident load between remaining, nondefective components or correspondingly handling the integrated error set reaction models.

6. The control arrangement as defined by claim 1, wherein the power electronics portion is disposed directly on a valve of the valve-controlled hydrostatic displacement machine, and the at least one control unit sends a control signal, generated therefrom, directly to the valve containing the power electronics portion.
